(19) United States
(12) Patent Application Publication
(10) Pub. No.: US 2009/0021556 A1
(43) Pub. Date: Jan. 22, 2009

(54) Imaging device

(76) Inventors: Xiangdong Zhao, Poway, CA (US); Geoffrey Schmid, San Diego, CA (US); Timothy J. Cartin, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,291

(22) Filed: Jul. 20, 2007

(51) Int. Cl. B41J 2/165

(52) U.S. Cl. 347/36

(57) ABSTRACT

An imaging device includes an ink collection structure.

### BACKGROUND

Imaging devices, such as printers, may include support structures, such as platens, that may secure a sheet of print media during printing of ink on the media. An overflow collection reservoir may be positioned adjacent the platen to catch overspray ink during printing. It may be desirable to increase the collection volume of the overspray collection reservoir to decease the frequency of servicing downtime of the imaging device.

### BRIEF DESCRIPTION OF THE DRAWINGS

FIG. 1 is a schematic side view of one example embodiment of an imaging device.

FIG. 2 is a schematic view of one example embodiment of a collection system of an imaging device.

### DETAILED DESCRIPTION OF THE DRAWINGS

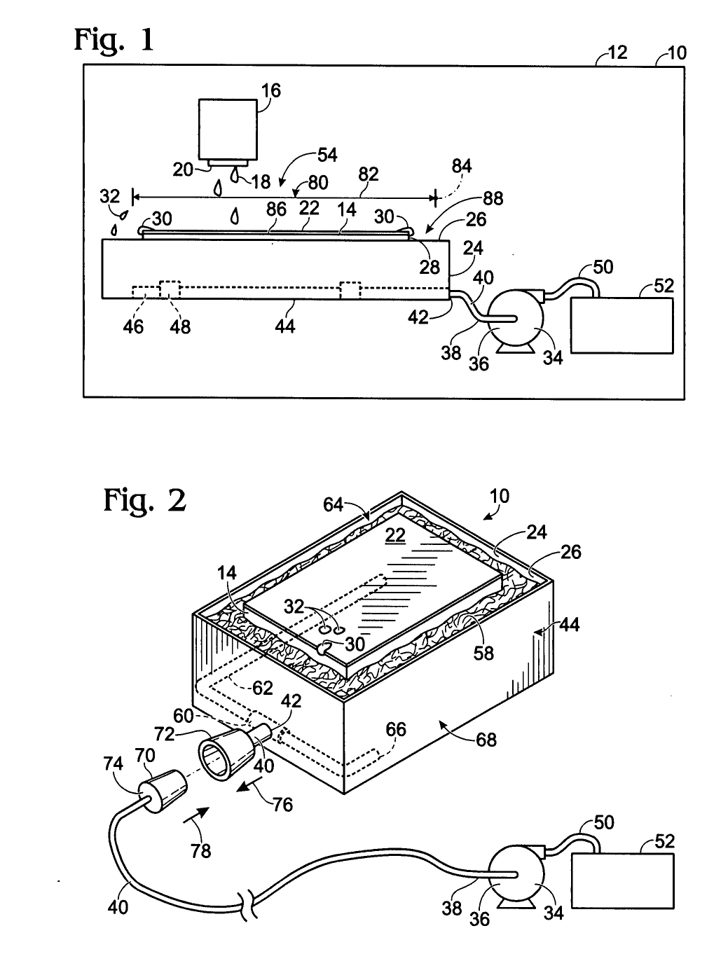

FIG. 1 shows one example embodiment of an imaging device such as a printer 10. Printer 10 may include a housing 12 that encloses a print media holddown structure such as a platen 14. A printing device, such as a printhead 16 may be movably positioned above platen 14 for printing ink 18 through a nozzle plate 20 onto a media 22 positioned on platen 14. An overflow collection structure, such as a collection reservoir 24 may be positioned adjacent platen 14. In the example embodiment shown, reservoir 24 defines a channel 26 that extends completely around a perimeter 28 of platen 14. Channel 26 of reservoir 24 is structured to collect overflow ink 30 and overspray ink 32 from platen 14 during printing of ink 18 onto media 22. In one embodiment, platen 14 may be a movable component of printer 10 such that reservoir 24, and channel 26, may be manufactured in a relatively small size.

Printer 10 may further include a pressure device 34 that includes a vacuum pump 36 connected to a first end region 38 of a vacuum tube 40. Vacuum tube 40 may extend through a drain aperture 42 in a lower region 44 of reservoir 24. A second end region 46 of tube 40 may be held in position within lower region 44 of reservoir 24 by fasteners, such as clips 48 that may be manufactured integral with reservoir 24. Pump 36 may operate to pull a vacuum through tube 40 such that overflow ink 30 and overspray ink 32 may be pulled from reservoir 24 through tube 40. In one example embodiment, pump 36 may be utilized for additional functions such as additionally being used as a print shuttle pump.

Pressure device 34 may further include a second vacuum tube 50 that may be connected to vacuum pump 36 and to a discharge collection reservoir 52 positioned remote from platen 14. During operation of pump 36, the pump may pull overflow ink 30 and overspray ink 32 from reservoir 24 and pump the ink through second vacuum tube 50 to discharge collection reservoir 52. Discharge collection reservoir 52 may be sized to hold a volume of overflow ink 30 and overspray ink 32 that is larger than a volume of ink that may be held within reservoir 24.

Accordingly, inclusion of pressure device 34 within printer 10 may decrease the frequency of servicing downtime of the printer 10 because the printer may continue operation while remote discharge collection reservoir 52 is emptied. In an embodiment where operation of printer 10 is stopped during emptying of discharge collection reservoir 52, the downtime of such a printer 10 may be less than the downtime of prior art printers in which a small volume collection reservoir positioned adjacent a platen is frequently serviced.

In the embodiment shown in FIG. 1, platen 14 and reservoir 24 may be stationary within printer 10 and may be manufactured of a rigid, inflexible material such as plastic, wherein the reservoir 24 does not come into contact with printhead 16. In other words, reservoir 24 positioned adjacent platen 14 is not a flexible capping member for capping printhead 16.

Still referring to FIG. 1, reservoir 24 may define an open top region 54 that may be exposed to atmospheric pressure. Accordingly, pump 36 may pull a vacuum on overflow ink 30 and overspray ink 32 contained within lower region 44 of reservoir 24 while reservoir 24 remains open to atmospheric pressure in open top region 54.

FIG. 2 shows one example embodiment of a collection system 56 of a printer 10. The collection system 56 may include reservoir 24 which defines channel 26 therein. An absorbent material, such as an absorbent foam 58 may be positioned throughout channel 26 for absorbing overflow ink 30 and overspray ink 32 from platen 14.

Collection system 56 may further include vacuum tube 40 extending through drain aperture 42 wherein tube 40 is connected to a tubing Tee joint 60. A first vacuum tube section 62 may be positioned within a first section 64 of channel 26 and may be connected to Tee joint 60. A second vacuum tube section 66 may be positioned within a second section 68 of channel 26 and may also be connected to Tee joint 60. By use of multiple tubing sections, such as sections 64 and 68, positioned in different sections of channel 26, the channel 26 may be effectively drained of overflow ink 30 and overspray ink 32 by pump 36. Absorbent foam 58 may be positioned on top of tubing sections 62 and 66 such that the tubing is positioned in a lower region 44 of reservoir 24 and such that gravity may pull ink downwardly from foam 58 into lower region 44 of reservoir 24. In one embodiment reservoir 24 may further include a foam retaining device, which may be positioned on top of foam 58, and which is not shown for ease of illustration.

In the embodiment shown in FIG. 2, tubing 40 may include therein a connection structure 70 that may include a cap 72 positioned on reservoir 24 and a mating prong 74 connected to pump 36. Prior to servicing of reservoir 24, i.e., prior to removal of overflow ink 30 and overspray ink 23 from reservoir 24 by pump 36, reservoir 24 may be moved in direction 76 such that cap 72 mates with prong 74 to define an airtight seal there between. In another embodiment prong 74 may be moved in direction 78 toward reservoir 24 or both the prong 74 and the cap 72 may be moved toward one another to define mating engagement there between. In other embodiments, cap 72 and prong 74 may have a different size, shape or position within printer 10.

Referring again to FIG. 1, printer 10 may define a printing region 80 including a length 82 and a width 84 (shown in end view) that may encompass a top surface 86 of platen 14 and a portion 88 of collection reservoir 24 positioned adjacent platen 14. Printhead 16 may be moved throughout printing region 80 to print an image on a media 22 positioned on platen 14. In one example embodiment wherein printer 10 is a photograph printer that prints a photographic image on a media 22 without borders, i.e., the image is printed on an entirety of media 22, the printing region 80 may extend over perimeter 28 of platen 14 and encompass portion 88 of collection reservoir 24 such that overspray ink 32 is sprayed into and collected by collection reservoir 24. Accordingly, printing region 80 may be described as including at least a portion of platen 14 and at least a portion 88 of collection reservoir 24 during printing.

Accordingly, one advantage of the collection system of the disclosed printer 10 may be reduced servicing of the printer 10, which may result in reduced downtime of the printer. Another advantage of the disclosed printer may be reduced servicing costs in that the absorbent material and/or the reservoir 24 may not be replaced during servicing. Another advantage of the disclosed printer is that reservoir 24 may be periodically purged of ink during operation thereby reducing the chance of ink spillage within printer 10 from reservoir 24.

Other variations and modifications of the concepts described herein may be utilized and fall within the scope of the claims below.

We claim:

1. An imaging device, comprising:
a media holddown structure;
a collection reservoir positioned adjacent said holddown structure, said reservoir structured to be spaced from a printhead during printing of ink by said printhead onto a print media on said holddown structure;
an absorbent material positioned within said reservoir; and
a vacuum device operatively connected to said reservoir and adapted for pulling a vacuum on said reservoir.

2. The device of claim 1 wherein said vacuum device includes a pump and a tube, said pump connected to a first end of said tube and wherein a second end of said tube is positioned within said reservoir and adjacent said absorbent material.

3. The device of claim 1 wherein said reservoir defines a channel positioned around a perimeter of said holddown structure.

4. The device of claim 1 further comprising a discharge ink container operatively connected to said vacuum device.

5. The device of claim 1 wherein said reservoir is stationary and wherein said reservoir is structured to be spaced from a printhead such that an airgap is present between said printhead and said reservoir and such that there is an absence of contact between said reservoir and said printhead during printing of ink by said printhead onto a print media on said holddown structure.

6. The device of claim 1 further comprising a printing region, and wherein at least a portion of said media holddown structure and at least a portion of said collection reservoir are both positioned in said printing region during printing.

7. The device of claim 2 wherein said second end of said tube is connected to a first tube arm positioned in a first section of said reservoir and to a second tube arm positioned in a second section of said reservoir opposite said first section of said reservoir.

8. The device of claim 7 wherein said first and second tube arms are positioned beneath said absorbent material.

9. The device of claim 1 wherein said reservoir receives overflow ink from said holddown structure during printing of ink on a media held on said holddown structure and wherein said vacuum device removes said overflow ink from said reservoir.

10. The device of claim 1 wherein said reservoir includes a top region open to atmospheric pressure during use.

11. A method of using an imaging device cleaning system, comprising:
depositing ink onto a media holddown structure, wherein a overflow portion of said ink overflows into a collection reservoir positioned adjacent said holddown structure;
collecting said overflow portion of said ink in an absorbent material positioned within said collection reservoir; and
pulling a vacuum on said collection reservoir to remove said overflow portion of said ink from said absorbent material and said collection reservoir.

12. The method of claim 11 wherein said pulling a vacuum comprises pulling a vacuum on a plurality of vacuum tubes positioned within said absorbent material.

13. The method of claim 11 wherein said removing said overflow portion of said ink comprises pumping said overflow portion of said ink into a discharge ink container positioned remote from said holddown structure.

14. The method of claim 13 further comprising replacing said discharge ink container with a replacement discharge ink container.

15. The method of claim 11 further comprising removing said vacuum on said collection reservoir after removal of said overflow portion of said ink.

16. An imaging device ink collection system, comprising:
a platen;
a overflow reservoir positioned adjacent said platen;
an absorbent material positioned within said overflow reservoir; and
vacuum structure positioned within said overflow reservoir and beneath said absorbent material.

17. The device of claim 16 further comprising a vacuum pump operatively connected to said vacuum structure.

18. The device of claim 16 wherein said overflow reservoir is positioned around a perimeter of said platen.

19. The device of claim 16 further comprising a collection reservoir connected to said vacuum structure and positioned remote from said platen.

20. The device of claim 16 wherein said platen and said overflow reservoir are stationary and manufactured of a rigid material.
